(19) United States
(12) Patent Application Publication
(10) Pub. No.: US 2009/0109684 A1
(43) Pub. Date: Apr. 30, 2009

(54) ENERGY SAVING LIGHT STRUCTURE

(76) Inventor: Chin-Mu Hsieh, Tainan Hsien (TW)

Correspondence Address: Dr. BANGER SHIA;Int''l Patent Office of Bang Shia, 102 Lindencrest Ct, Sugar Land, TX, 77479-5201, US

(21) Appl. No.: 11/925,819

(22) Filed: Oct. 27, 2007

(51) Int. Cl. F21V 7/04

(52) U.S. Cl. 362/297

(57) ABSTRACT

An energy saving light structure includes a socket and an energy saving bulb mounted in the socket. The socket is provided with an oval spherical multi-reflector on the inner wall of the socket. The multi-reflector has a number of rectangular reflecting plates connected in series. The multi-reflector is formed with a concave oval spherical reflecting section. The inner wall of the reflecting section is formed with a corrugated reflecting surface to enhance the illumination effect and save energy.

### BACKGROUND OF THE INVENTION

1. Field of the Invention

The present invention relates to an energy saving light structure, and more particularly to a light bulb socket provided with an oval spherical multi-reflector which has an oval spherical concave as a reflecting section to enhance lighting effect and to save energy.

2. Description of the Prior Art

A conventional lighting structure, as shown in FIG. 6, comprises a light socket A and a reflection plate A1 having a number of bulges. The light socket A is mounted with a powerful light bulb A2. A sensor A3 is provided under the light socket A. When it is dark and a person walks in front of the lighting structure, the person will be detected by the sensor A3 and the powerful light bulb A2 will be activated to emit light. However, the powerful light bulb A2 consumes a lot of electric energy. Furthermore, the reflection plate A1 in the socket A is formed by cutting the surface to form a tangent angle which can not provide the best light reflection.

### SUMMARY OF THE INVENTION

According to the present invention, there is provided an energy saving light structure comprising a socket and an energy saving bulb in said socket, characterized in that said socket is provided with an oval spherical multi-reflector therein, said multi-reflector being formed with a number of rectangular reflecting plates connected in series, each said reflecting plate having an arc cross-section, said multi-reflector being formed with a concave oval spherical reflecting section, said reflecting section having a corrugated reflecting surface at an inner wall of said reflecting section.

Preferably, said socket is provided with a pair of electrical outlets on inner sides thereof for said energy saving bulb to be secured thereon.

Preferably, the energy saving bulb has its light beaming forward along the axis of the light and focusing at four center meters.

Preferably, each said reflecting plate has a width side in vertical with the ground and a lengthy side in parallel with the ground.

Preferably, said reflecting section has an open length larger than that of said multi-reflector.

It is the primary object of the present invention to provide an energy saving light structure, which has a concave reflecting section, allowing the lighting source to be mounted closer to the reflecting section, and is easier for the user to replace the light bulb when necessary. This concave design also increases the solid angle of the light source from the multi-reflector.

It is another object of the present invention to provide an energy saving light structure, which collects the lights emitting from the rear of the light source and emitting outward.

It is a further object of the present invention to provide an energy saving light structure, which forms a beam pattern at four center meters in front of the light source, providing the best lighting effect.

It is still a further object of the present invention to provide an energy saving light structure, which uses the energy saving bulb, the multi-reflector and the reflecting section to provide a brighter atmosphere and consume less energy.

### BRIEF DESCRIPTION OF THE DRAWINGS

FIG. 1 is an exploded view of the present invention;

FIG. 2 is a perspective view of the present invention;

FIG. 3 is a cross-sectional view of the present invention;

FIG. 4 is a side view of the present invention showing that the open length of the reflecting section is larger than that of the multi-reflector;

FIG. 5 is a cross-sectional view of the present invention showing light reflecting path; and

FIG. 6 is a front view of the prior Art.

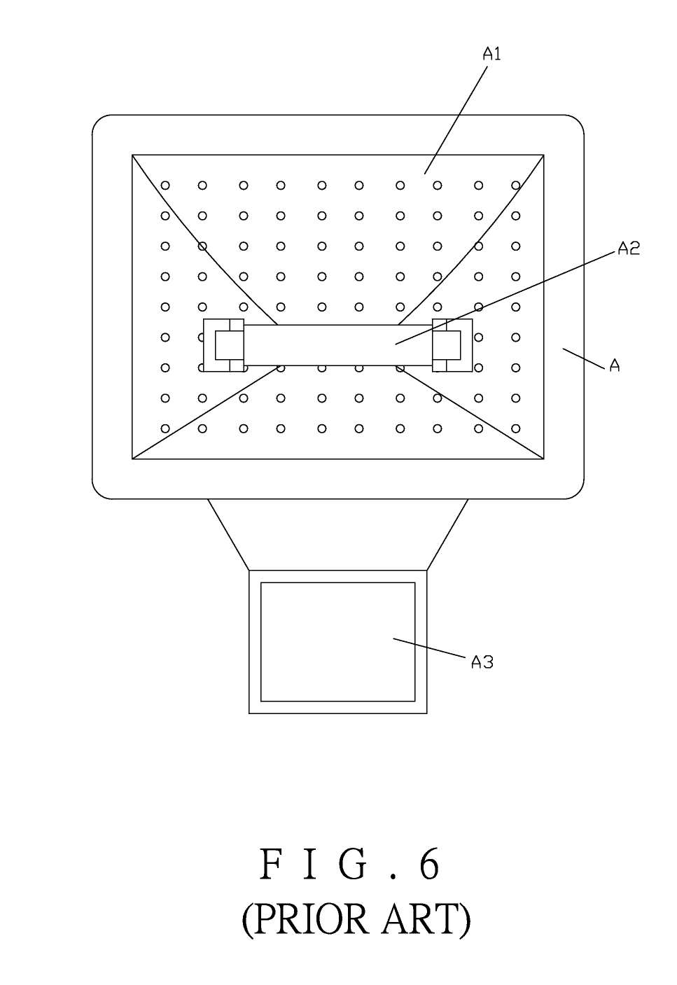

### DETAILED DESCRIPTION OF THE PREFERRED EMBODIMENT

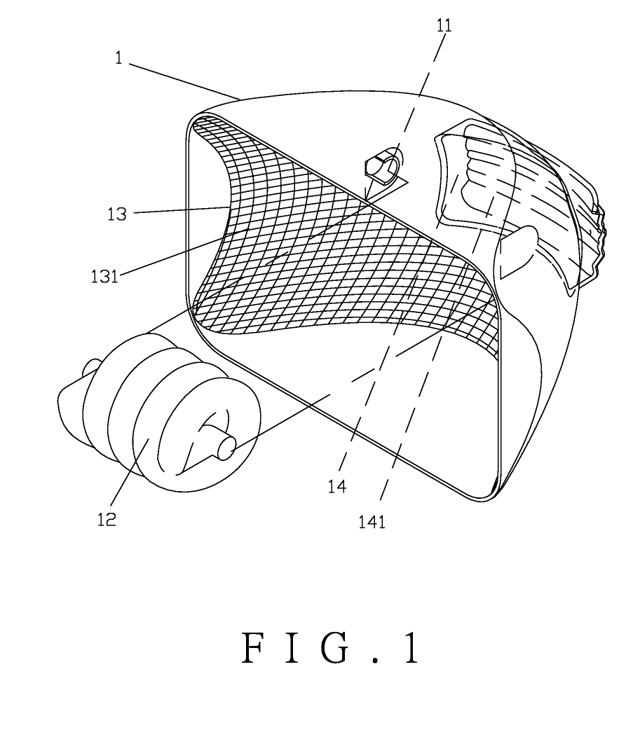

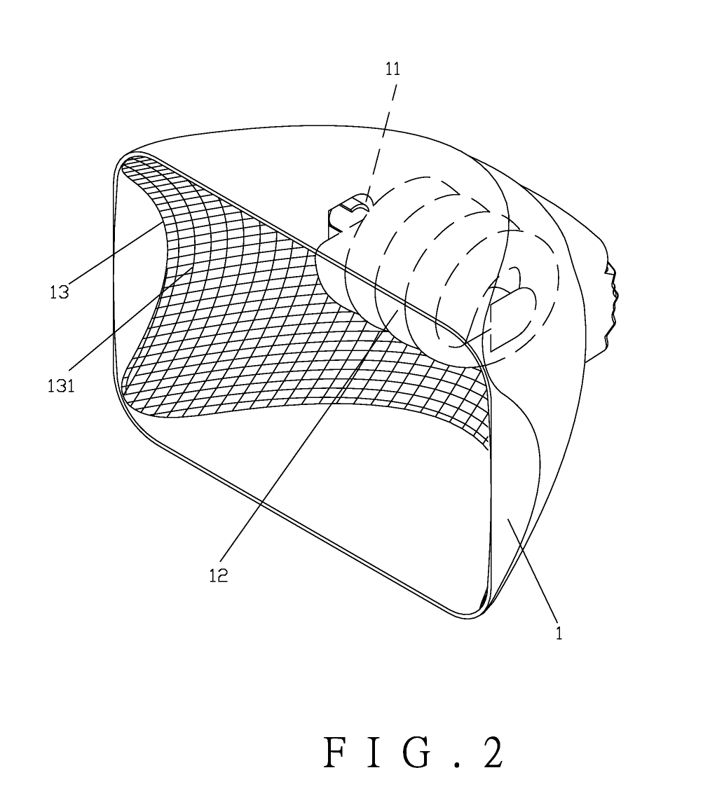

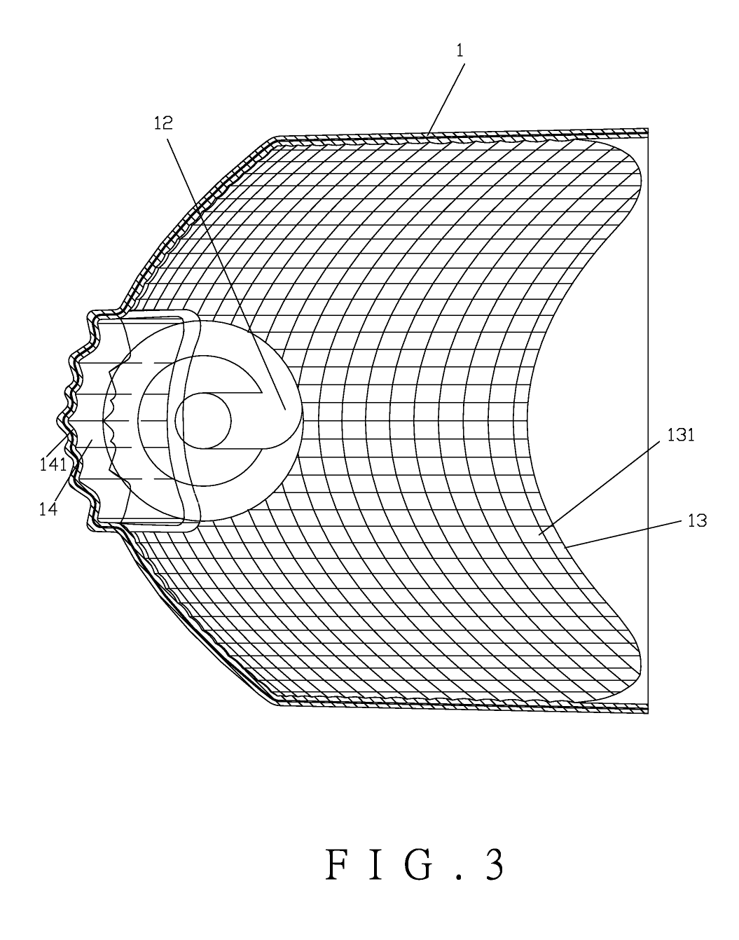

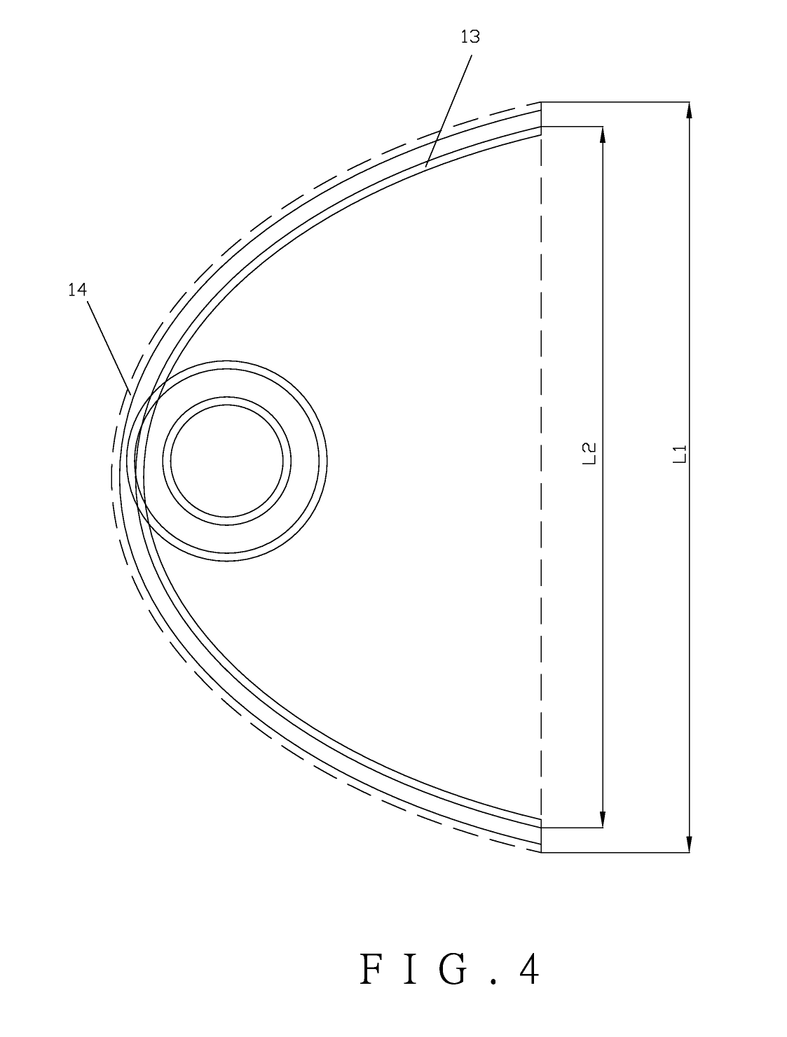

An energy saving light structure of the present invention, as shown in FIGS. 1 and 2, comprises a rectangle-like socket 1 with a pair of electrical outlets 11 on inner sides of the socket 1 and a light source 12 mounted in the socket 1. The light source 12 is an energy saving bulb having two contact points to be secured with the two electrical outlets 11 for securing purpose as well as power supply. The light source 12 has its light beaming forward along the axis of the light and focusing at four center meters which is deemed as the best focusing point. The socket 11 is provided with a multi-reflector 13 on the inner wall of the socket 11. The multi-reflector 13 is in oval spherical shape and has a number of rectangular reflecting plates 131 connected in series. The width side of each reflecting plate 131 is in vertical with the ground while the lengthy side is in parallel with the ground. The cross-section of the reflecting plate 131 is in arc shape (as shown in FIG. 3), which has the center portion bulged outward. The multi-reflector 13 comprises a reflecting section 14 which is concave to form an oval spherical reflecting section thereat for the light source 12 to be mounted thereon. The inner wall of the reflecting section 14 is formed with a corrugated reflecting surface 141. The open length (which is represented by L1) of the reflecting section 14 is larger than that (which is represented by L2) of the multi-reflector 13, as shown in FIG. 4.

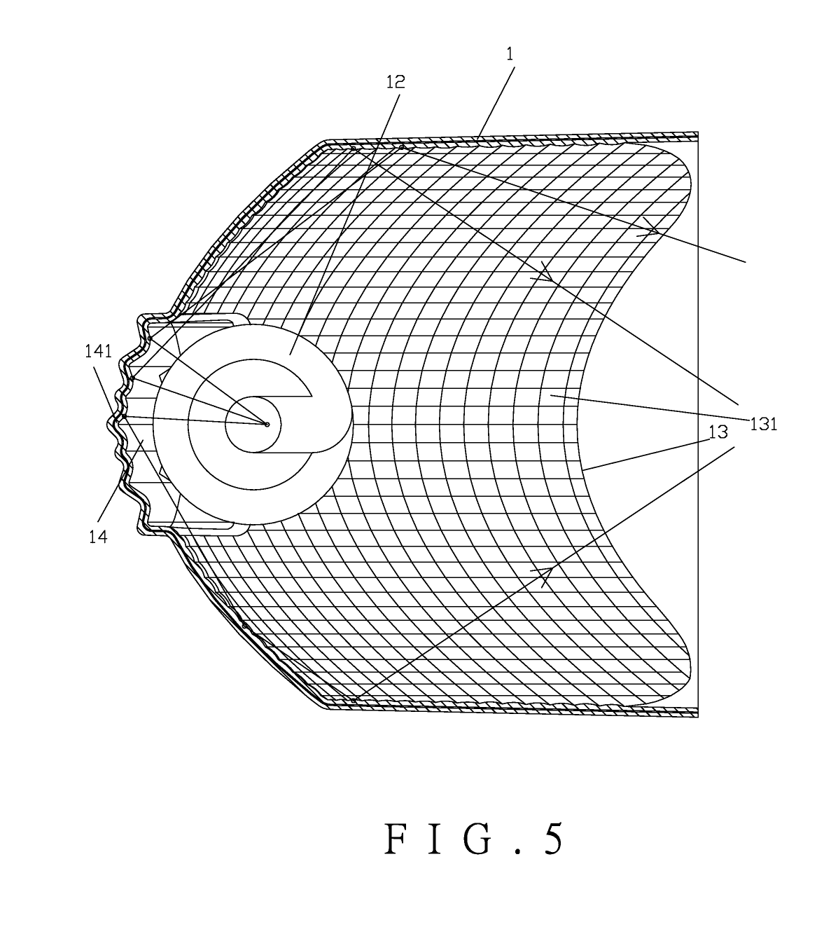

To operate the present invention, as shown in FIG. 5, when it is necessary to replace the light source 12, the multi-reflector 13 will not interfere with this job because the light source 12 is disposed near the reflecting section 14. This design also increases the solid angle of the light source 12 from the multi-reflector 13. The reflecting surface 141 of the reflecting section 14 is able to collect the light from the rear of the light source 12 and emits outward. This will avoid the light from being blocked. When the light source 12 is activated, the light will be collected by the reflecting surface 141 of the reflecting section 14 and reflected to the upper and lower reflecting plates 131 of the multi-reflector 13, which then produces a secondary reflection. Because the reflecting plates 131 of the multi-reflector 131 are all made of rectangular shape, all light will be shot to the four center meters of the front direction to form a beam pattern to achieve the best effect.

What is claimed is:

1. An energy saving light structure comprising a socket and an energy saving bulb in said socket, characterized in that:
said socket is provided with an oval spherical multi-reflector therein, said multi-reflector being formed with a number of rectangular reflecting plates connected in series, each said reflecting plate having an arc cross-section, said multi-reflector being formed with a concave oval spherical reflecting section, said reflecting section having a corrugated reflecting surface at an inner wall of said reflecting section.

2. The energy saving light structure, as recited in claim 1, wherein said socket is provided with a pair of electrical outlets on inner sides thereof for said energy saving bulb to be secured thereon.

3. The energy saving light structure, as recited in claim 1, wherein the energy saving bulb has its light beaming forward along the axis of the light and focusing at four center meters.

4. The energy saving light structure, as recited in claim 1, wherein each said reflecting plate has a width side in vertical with the ground and a lengthy side in parallel with the ground.

5. The energy saving light structure, as recited in claim 1, wherein said reflecting section has an open length larger than that of said multi-reflector.
